(19) United States
(12) Patent Application Publication
(10) Pub. No.: US 2004/0197537 A1
(43) Pub. Date: Oct. 7, 2004

(54) Barium cadmium tantalum-based compound having high dielectric properties and method of making the same

(76) Inventors: Nathan Newman, Scottsdale, AZ (US); Mark van Schilfgaarde, Tempe, AZ (US); Shaojun Liu, Tempe, AZ (US); Jihoon Kim, Chandler, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/611,780

(22) Filed: Jun. 30, 2003

Related U.S. Application Data
(60) Provisional application No. 60/392,379, filed on Jun. 28, 2002.

(51) Int. Cl. C04B 35/495

(52) U.S. Cl. 428/209; 428/701; 428/689; 428/901; 501/135

(57) ABSTRACT

A class of material having barium, cadmium, and tantalum provides high dielectric constant and low loss for use in electronic and optical applications. The material may also contain an element with valence 2 such as magnesium and zinc. Transition metal dopants can also be added to reduce annealing time and/or to tune the temperature-coefficient of resonant frequency. The dielectric material can be made in ceramic or thin film form. The process begins with a mixture of barium carbonate, zinc oxide, tantalum oxide, and cadmium oxide blended together. The slurry is dried and heated. A sintering agent is added to produce high-density samples. The resulting slurry is dried and an adhesive is added to press the mixture into a solid ceramic samples. Thin film dielectric material is made with a thin film growth technique, such as by exposing the mixture to a laser and growing the material on a substrate.

### CLAIM TO DOMESTIC PRIORITY

The present non-provisional patent application claims priority to provisional application serial No. 60/392,379, entitled “Synthesis & Development of New Compounds with Improved Characteristics for Photonic Applications”, and filed on Jun. 28, 2002, by Nathan Newman et al.

### GOVERNMENT LICENSE RIGHTS

The U.S. Government has a paid-up license in this invention, and the right in limited circumstances to require the patent owner to license others on reasonable terms, as provided by the terms of Office of Naval Research Office Grant Number N00014-00-1-0550.

### FIELD OF THE INVENTION

The present invention relates in general to dielectric materials and, more particularly, to a Barium Cadmium Tantalum-based material having excellent dielectric properties.

### BACKGROUND OF THE INVENTION

Dielectric materials are used in a myriad of applications such as high frequency filters, semiconductors, optical devices, and electronic communications. For example, the use of low-loss, temperature-compensated materials with enhanced dielectric constants are useful in the operation and miniaturization of satellite communication, cellular phones, and other wireless communication systems.

A number of dielectric materials have been used in ceramic form, including Ba₂Ti₉O₂₀, BaTi₄O₉, Zr₁₋ₓSnₓTiO₄, Ba(Zn_{1/3}Ta_{2/3})O₃, Ba₆₋₃ₓRE₈₊₂ₓTi₁₈O₅₄, and related perovskite compounds. In particular, Ba(Zn_{1/3}Ta_{2/3})O₃ and Ba(Mg_{1/3}Ta_{2/3})O₃ have shown potential for use in microwave systems due to their high frequency properties. Ba(Zn_{1/3}Ta_{2/3})O₃, for example, has a dielectric constant ε˜30 and low loss tangent tan δ<2×10⁻⁵ at 2 GHz. Furthermore, when doped with Nickel (Ni), its temperature coefficient of resonant frequency, τ_{f}, can be tuned to a low value. Zirconium (Zr) is also commonly added since it has been found that high quality factors (Q) can be obtained with its use in much shorter annealing times and over a wider range of stoichiometries.

Research continues to understand why such classes of materials as described above can have both a good dielectric constant and a reasonably low loss. A number of experimental and theoretical investigations have been proposed that the predominant microwave loss mechanism may be related to the low-energy tail of anharmonic lattice vibrations. A number of material properties have shown to be correlated with loss. For example, Ba(Zn_{1/3}Ta_{2/3})O₃, also referred to herein as BZT, has sometimes been found to have an inverse relationship between Zn—Ta site ordering, typically referred to as B-site ordering in A(B_{1/3}Ta_{2/3})O₃ perovskites, and the loss tangent at microwave frequencies. The high-quality factors and B-site ordering could be attained through high temperature annealing at 1350° C. for extended periods up to 120 hours. Microwave loss in other materials, including Sn-doped ZrTiO₄, has also been correlated with cation ordering. The addition of BaZrO₃ to BZT have resulted in low loss even without extended annealing times and significant B-site ordering, which has been attributed to various factors, including specific atomic configurations at grain boundaries. The amount of impurities in the material has also been correlated to the microwave loss. There may also be a direct correlation between microwave loss and the concentration of point defects. Clearly, the role of intrinsic and extrinsic factors in the microwave loss process in these materials is just beginning to be understood.

### SUMMARY OF THE INVENTION

In one embodiment, the present invention is a dielectric comprising a solid material including elements of barium, cadmium, and tantalum.

In another embodiment, the present invention is an electronic device comprising a region providing an electrical function. The region includes a solid material having at least elements of barium, cadmium, and tantalum. An electrical terminal is connected to the region.

### BRIEF DESCRIPTION OF THE DRAWINGS

FIG. 1 is a receiver circuit with resonator filter;

FIG. 2 illustrates the region of the resonator filter including the BCT material;

FIG. 3 illustrates the steps of making the BCT material in ceramic form;

FIG. 4 illustrates the resulting BCT material in puck form;

FIG. 5 illustrates the steps of making the BCT material in thin film form;

FIG. 6 illustrates mass loss from BCT as a function of time and temperature;

FIG. 7 illustrates an X-ray diffraction spectrum of decomposed BCT material;

FIG. 8 illustrates an Ellingham diagram for BCT material;

FIG. 9 illustrates an X-Ray diffraction spectra of synthesized Ba(CdₓZn_{1/3-x}Ta_{2/3}) solid solution powder where x is equal to (a) 1/12, (b) 1/9, (c) 2/9 and (d) ¼;

FIG. 10 illustrates X-Ray diffraction spectra of sintered BCT ceramic material synthesized with 2 wt % ZnO as sintering additive as a function of sintering temperature;

FIG. 11 illustrates some Qf product data for BCT ceramic material synthesized with 2 wt % ZnO sintering agent over a range of sintering temperatures;

FIG. 12 illustrates X-Ray diffraction spectra of BCT ceramic material with 0.5 wt % B annealed at 1050° C.;

FIG. 13 illustrates X-Ray diffraction spectra of BCT ceramic material with 0.1 wt % B annealed at 1250° C.;

FIG. 14 illustrates the effect of annealing time on the microwave property of BCT ceramic material annealing at 1050° C.;

FIG. 15 illustrates a ball and stick model of the BCT compound;

FIG. 16 illustrates the electronic energy band structure of BCT; and

FIG. 17 illustrates energy as a function of the generalized spatial coordinate Q.

### DETAILED DESCRIPTION OF THE DRAWINGS

The present invention uses a Barium (Ba) Cadmium (Cd) Tantalum (Ta)-based compound and alloys as a dielectric material. The compound and/or alloys can be expressed by the chemical formula Ba(CdₓM_{y}Ta_{z})O₃, wherein M is an element with valence 2 preferably zinc (Zn) or magnesium (Mg), x+y+z=1, and x is not equal to zero, although y can be equal to zero, hereinafter referred to as BCT. Accordingly, cadmium is present in the compound with a well defined ratio with tantalum over a range of values. The cadmium may be combined in a particular ratio with zinc or magnesium to form a particular alloy. In certain embodiments, the material comprises Ba(CdₓZn_{1/3-x}Ta_{2/3})O₃ alloys and Ba(Cd_{1/3}Ta_{2/3})O₃ compound in powder, ceramic, thin film, and single crystal form. In other embodiments, the material comprises Ba_{1+y}(Cdₓ₊ₐM_{1/3-x}Ta_{2/3})O_{3+z} alloys, and Ba_{1+y}(Cd_{1/3+a}Ta_{2/3})O_{3+z} in powder, ceramic, thin film, and single crystal form where the material is made off-stoichiometric, i.e. −0.1<a<0.1, 0<x<0.333, −0.1<y<0.1 and −0.1<z<0.1. Yet another embodiment can be realized when additives, or their oxides, such as those containing Ni, Zr, Zn and/or B, are used to adjust the temperature-coefficient of the resonant frequency and/or reduce the sintering temperature or time to obtain high Qs or high density.

The above compound and alloys exhibit large dielectric constant (ε), ultra-low microwave loss, and a tunable near-zero temperature coefficient of resonant frequency. One factor contributing to the enhanced dielectric properties in the present BCT material is the d-electron directional bonding which is stronger in Cd-containing compounds as compared to other A(B_{1/3}Ta_{2/3})O₃ perovskites, where A and B refer to the A-site typically occupied by a larger group II element such as Ba and the B-site typically occupied by a group II element such as Zn or Mg, respectively. In particular, the above class of BCT materials has been shown to exhibit high dielectric constants on the order of ε˜30 at about 1 kHz. Transition metal dopants such as Zr can improve the performance of the BCT material while reducing annealing time. Ni can be used to tune the temperature-coefficient of resonant frequency, τ_{f}.

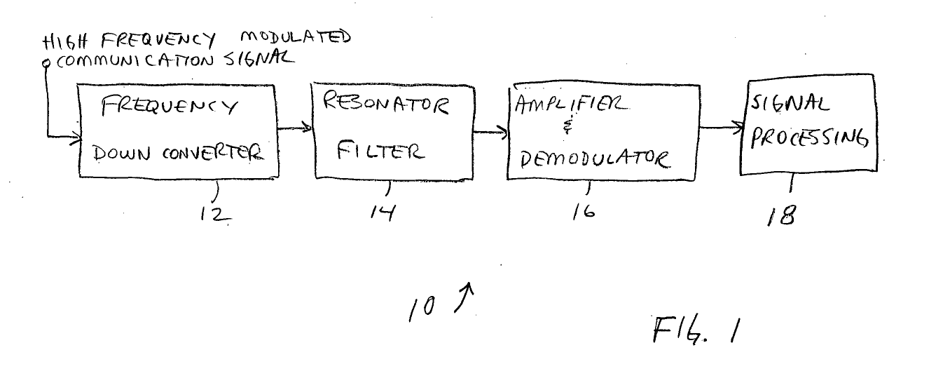

The high dielectric and low loss properties make the present class of BCT materials useful for high quality-factor (O) microwave resonators, filters, and other high-frequency and wireless electronic device applications. A receiver circuit 10 is shown in FIG. 1 for use in microwave or wireless communication applications. Receiver circuit 10 receives a high frequency, e.g. radio frequency (RF) or microwave, communication signal. Frequency downconverter 12 down-converts the communication signal to a baseband frequency. The baseband signal is received on a terminal of resonator filter 14. Resonator filter 14 removes spurious noise in the sidebands and isolates the desired frequency for further signal processing. Amplifier and demodulation circuit 16 amplifies the baseband signal and removes the modulation component. The demodulated baseband signal undergoes further signal processing in circuit 18.

Resonator filter 14 is responsive to the wavelength of incident signals. If the wavelength of the incident signal is greater than or less than a physical length or dimension of the resonator, then there is no reaction and the communication signal is rejected. If the wavelength of the incident signal matches as an integral fraction or integral multiple of an effective resonant length of the resonator, then the resonator amplifies the signal at the resonant frequency as the energy from incident signal is coupled into filter 14.

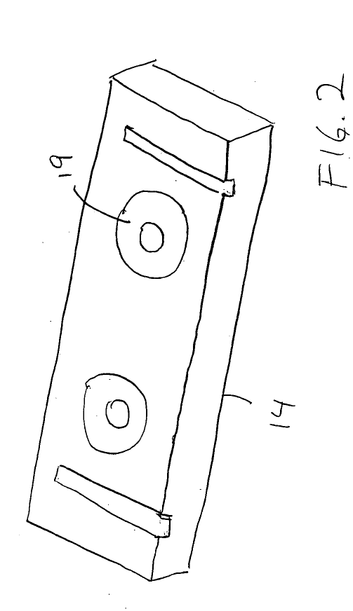

Turning to FIG. 2, resonator filter 14 has a region 19 made, in part, with a dielectric material including the present BCT compound or alloy. The region provides an electrical function, which in this case, is that of a resonator. A desirable feature of the resonator is to have a high Q-factor. A principal limitation in modern wireless communications is the Q-factor of oscillator and filter circuits. The higher the Q-factor, the greater or steeper the roll-off of the filter frequency response and accordingly the effectiveness of the filter. Resonator filter 14 has greater or sharper frequency selectivity with the high Q-factor allowing more data to be transmitted in the overall frequency band over longer distances in narrower frequency slots. In addition, the components can be miniaturized.

The high Q-factor for resonator filter 14 comes from the high dielectric constant and low loss properties of the BCT material. The low loss may be attributed to a component of the d-electron directional bonds, which in turn influences its phonon and electronic structure. By varying the M:Cd ratio (e.g. Zn:Cd ratio), the dielectric constant and other important microwave properties can be precisely adjusted and controlled. In another aspect, sintering agents and transition metal dopants may be added to the material to improve performance, improve manufacturability of the powders and ceramics, and tune the temperature coefficient of resonant frequency.

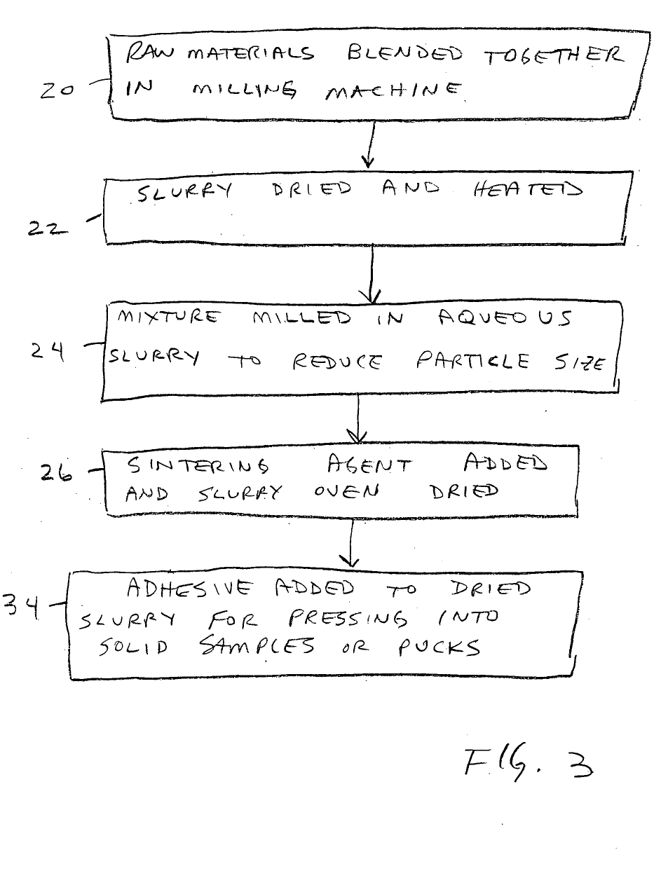

One type of process used to make the single-phase BCT material in a solid solution such as a ceramic is described in FIG. 3. In step 20, a powder form of raw materials including reagent grade Barium carbonate (BaCO₃), zinc oxide (ZnO), tantalum oxide (Ta₂O₅), and cadmium oxide (CdO) are blended together with ZrO₂ milling ball media having a diameter of about 1 centimeter (cm) and distilled water for 16 hours in a milling machine. The mill machine deagglomerates the powders and provides a homogeneous distribution of the raw materials in the form of slurry. The weight ratio between milling ball and powder is about 20:1. In step 22, the slurry is dried and then filtered through a 14-mesh screen. The powder is heated in a box furnace to 1350° C. for 10 hours with an initial ramp of 100° C./hour to bring about reaction of the raw materials to form single-phase materials. In step 24, the mixture is milled in aqueous slurry mixing a poly(vinylacohol-poly)(ethylene glycol) to reduce the particle size to that suitable for pressing. The enhanced directionality of the bonds may require additional sintering agents to produce high-density ceramic samples. In step 26, for BCT powder and solid solutions containing Zinc, e.g. Ba(Cd_{1/6}Zn_{1/6}Ta_{2/3})O₃, a sintering agent such as 2 wt % ZnO powder is added to produce high-density ceramic samples. The resulting slurry is dried in an oven at 60° C. to produce agglomerates suitable for pressing. Boron (B) as a sintering aid can also reduce the sintering temperature, enhance the structural quality, and improve the microwave properties of Ba(Cd_{1/3}Ta_{2/3})O₃ ceramic dielectrics. The addition of as little as 0.01 wt % B decreases the required sintering temperature from 1500° C. to about 1200-1300° C., and increases the relative density to 95% of the theoretical value. In step 34, a glue or adhesive is added to the dried slurry, which is then pressed using a binder into solid solution ceramic samples, e.g. in the form of pucks. The pressed ceramic puck 36 is shown in FIG. 4. Puck 36 is sintered in air with 2 wt % ZnO agent in a refractory crucible, for example, Pt or Pt-lined alumina, at 1450-1580° C. for 48 hours with an initial ramp of 100° C./hour. The glue or adhesive evaporates. The samples are allowed to cool slowly to yield a solid poly-crystalline BCT ceramic material. Other methods to make the BCT ceramic dielectric material include: solid state reaction synthesis; mechanical activation synthesis by mechanical alloying the mixture of barium oxide, cadmium oxide and/or zinc oxide, and tantalum oxide at room temperature; possible chemistry-based processing to synthesize the nanosized BCT including co-precipitation, sol-gel synthesis, alkoxide hydrolysis, and citrate routes.

The BCT ceramic material can be cut, shaped, powder injection molded or formed into a variety of shapes and sizes to function as passive circuit elements such as resonators, waveguides, antenna substrates, and shielding for high-frequency and wireless electronic applications. Other applications for the BCT material include optical devices, such as optical filters, lasers and light emitting diodes (LEDs), and solar cells.

The microwave properties of ceramic samples have sufficiently high Q-factor for high-performance microwave applications, on the order of Q>10,500 for frequencies >3.3 GHz and Q>7,200 for frequencies >6.2 GHz. The measured diffraction spectra of pure BCT samples fired at 1550° C. for 48 hours contain superstructure peaks, characteristics of cation ordering. A graphite single crystal is used to monochromitize the reflected X-ray beam. Bragg reflections are labeled using the powder diffraction convention of cubic BZT with space group Pm3m (221).

Ba(ZnₓCd_{1/3-x}Ta_{2/3})O₃ solid solutions have been synthesized over the entire range of solid solutions. While Ba(ZnₓCd_{1/3-x}Ta_{2/3})O₃ alloy ceramics with high densities generally do not require a sintering agent, the addition of 2 wt % ZnO and/or boric oxide helps achieve over 97% of the theoretical density for pure BCT ceramics. For a sample sintered at 1550° C. for 48 hours, the dielectric constant is measured to be 30 and microwave loss tangent is measured to be 5×10⁻⁵ at 2 GHz. For a sample sintered at 1350° C. for 4 hours, the dielectric constant is measured to be 30 and microwave quality (Q*f) is measured to be about 21000. The addition of boron improves further the microwave properties by annealing at 1050° C. for 20 hours in air. The dielectric constant, microwave quality, and the temperature coefficient of resonant frequency are measured to be approximately 35, 50000, and 70 ppm/° C., respectively.

Local density functional calculations of BCT and BZT give some insight into the nature of the present class of material. The conduction band maximum (CBM) and valence band minimum (VBM) are strongly composed of weakly itinerant Ta-5d and Zn-3d/Cd-4d levels, respectively, which plays a role in a high melting temperature and enhanced phonon energies, as well as having both a high dielectric constant and low loss tangent.

Next consider a process of making the single-phase BCT solid solution in a thin film form as described in FIG. 5. One method of fabricating BCT thin film samples uses pulsed laser deposition (PLD) in a ultra high vacuum (UHV) chamber. Other thin film growth methods that could be used include sputtering, co-evaporation, molecular beam epitaxy, and chemical vapor deposition. In step 40, a powder form of raw materials including reagent grade BaCO₃, ZnO, Ta₂O₅, and CdO are blended together to provide a homogeneous slurry as described in step 20 above. In step 42, similar to step 22, the slurry is dried to form a single-phase material as the BCT target. In step 44, an argon-fluoride (ArF) excimer laser operating at 248 nanometer (nm) wavelength is used to ablate the BCT target. In step 46, BCT films are grown on 1 cm×1 cm MgO (100) substrate, where 100 refers to the crystalline direction. A laser power of 2 J/cm² is exposed at the BCT target with a 10 Hz repetition rate while the target and substrate are kept at a distance of 7 cm. Oxygen (O) gas is used to prevent the loss of oxygen in the film during the growth.

Due to the relatively high vapor pressure of Cd in BCT films, high substrate temperatures can result in the decomposition of BCT films. The growth condition is improved by varying oxygen pressure and growth temperature. High quality crystalline BCT thin films are obtained at 625° C. with an oxygen partial pressure of 250 mTorr. The growth rate is about 1-2 Å/pulse.

Phase stability of BCT has been studied using a thermogravimetric measurement system as further discussed below. In each run, the mass loss of powder is monitored over constant temperature ramp as a function of time. The BCT powders are allowed to decompose to completion.

The ceramic BCT samples have also been characterized using an X-ray diffractometer with Cu Ka radiation and shown to be almost exclusively composed of a single-phase material. The lattice constants are determined by fitting at least 6 of the dominant diffraction peaks in the spectra using a least squares error minimization fit with the pattern indexing feature. Simulations of X-Ray diffraction spectra are performed using a pattern calculation.

Immersion pycnometry is used to quantitatively determine the density for high-density samples. The bulk density of other samples is evaluated by measuring the dimensions and weight of samples.

The Q-factor, dielectric constant, and temperature coefficient of resonant frequency are measured with the T_{01δ} mode of a dielectric resonator. The unloaded quality factor (O) is determined using VSWR to measure Q₀ and coupling of the dielectric sample in a resonant cavity. The procedure involves placing the cylindrical dielectric resonator (DR) sample to be measured in a gold (Au)-coated aluminum cylindrical cavity of dimensions approximately three times greater than the measured sample. The T_{01δ} mode is measured using S11 reflection data at the terminals of the one port cavity. S11 data is collected spanning the resonant frequency and the immediate lower and upper frequency bounds and processed using a fractional linear curve fitting routine and then graphically displayed as a Q circle on a Smith chart. Values of Q₀, loaded Q, and the coupling coefficient are also displayed. The routine uses the over-determined system of equations derived from the S11 data. The DR method is limited to about +20% accurately due to the near-field coupling between the dielectric resonator and the metal resonant cavity. However, it can give reasonable trends between materials if similar size dielectric samples are used.

To accurately determine the dielectric constant, a different technique is used which utilizes an open sided, parallel plate holder. The DR sample of known dimensions is placed between the plates of the two-port holder and connected to a vector network analyzer in transmission mode. The coupling probes of the two ports are either magnetic loops or electric probes that can be oriented both horizontally and vertically. The resonant frequency of the desired T_{01δ} mode to be measured can be isolated. Once the resonant frequency is identified, transcendental formulations are utilized and compared to provide the DR sample dielectric constant. Root finding and graphing routines can then be used to extract the value for the dielectric constant for each DR sample.

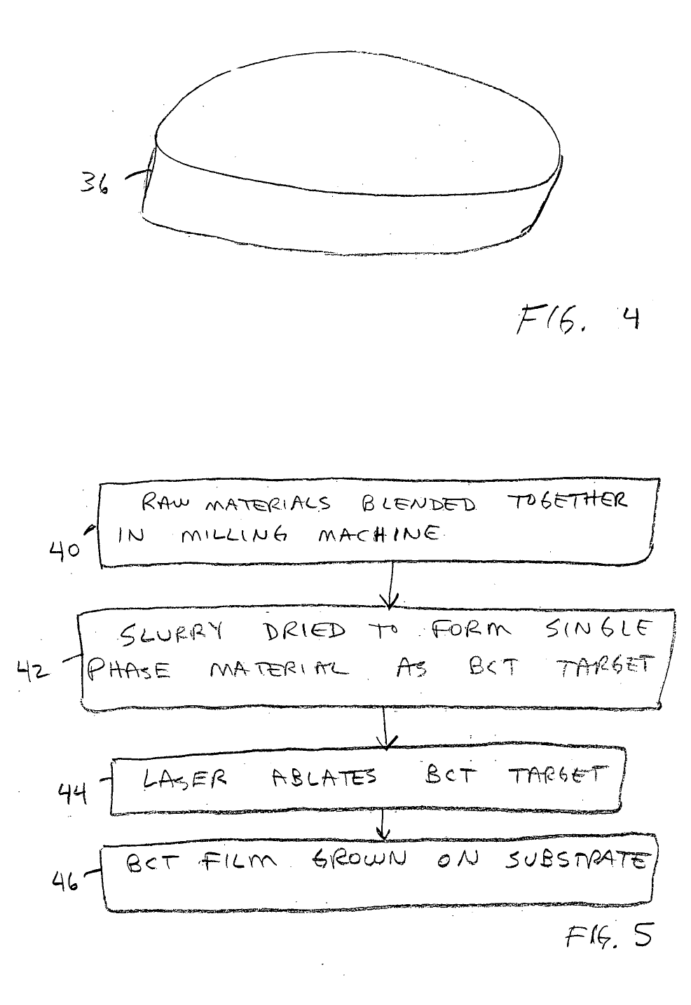

FIG. 6 shows thermogravimetry experiments that measure the mass loss of the BCT material as a function of time and temperature. BCT is found to decompose to Ba₅Ta₄O₁₅ and Ba₄Ta₂O₉ according to the following reaction:

3Ba₃(CdTa₂)O₉(s)→Ba₅Ta₄O₁₅(s)+Ba₄Ta₂O₉(s)+3CdO(g)

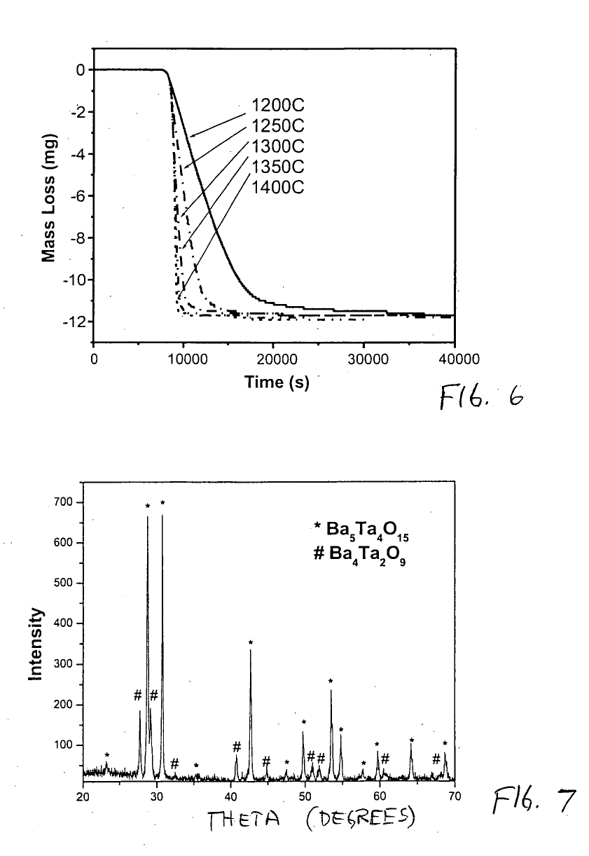

The above reaction is shown in FIG. 7 as the X-ray diffraction pattern of the residual decomposed BCT product after exposure to 1500° C. during the thermogravimetry measurements. Evidence of the presence of secondary Ba₄Ta₂O₉ and Ba₅Ta₄O₁₅ phases can be seen.

The evaporation flux under equilibrium conditions is determined by the Hertz-Knudsen-Langmuir equation: Jᵥ=Pₑ (2πmkT)^{-1/2}, where m is the molecular mass, k is the Boltzmman constant, and T is the temperature. Under conditions in which kinetic barriers are small, the thermodynamic parameters for a thermally activated process can be deduced from: ΔG=−RT1nK and ΔG=ΔH−ΔS*T, where K is the reaction equilibrium constant and equals the partial pressure of CdO, and ΔG, ΔH, and ΔS correspond to Gibbs free energy, enthalpy and entropy changes, respectively.

The evaporation rate, as inferred from the Hertz-Knudsen-Langmuir equation and the mass loss rate at maximum slope for each isothermal run, is plotted in FIG. 8. From this analysis, AH and AS of the decomposition reaction are determined to be 170.82 KJ/mol and 113.07 J/mol.T⁻¹, respectively. The plot represents a pressure-temperature phase diagram that is divided into two areas by the critical stability line. Above the line, the BCT material is stable. The results show that BCT can partially or fully decompose at the sintering temperature and pressures at proper temperature and partial pressure.

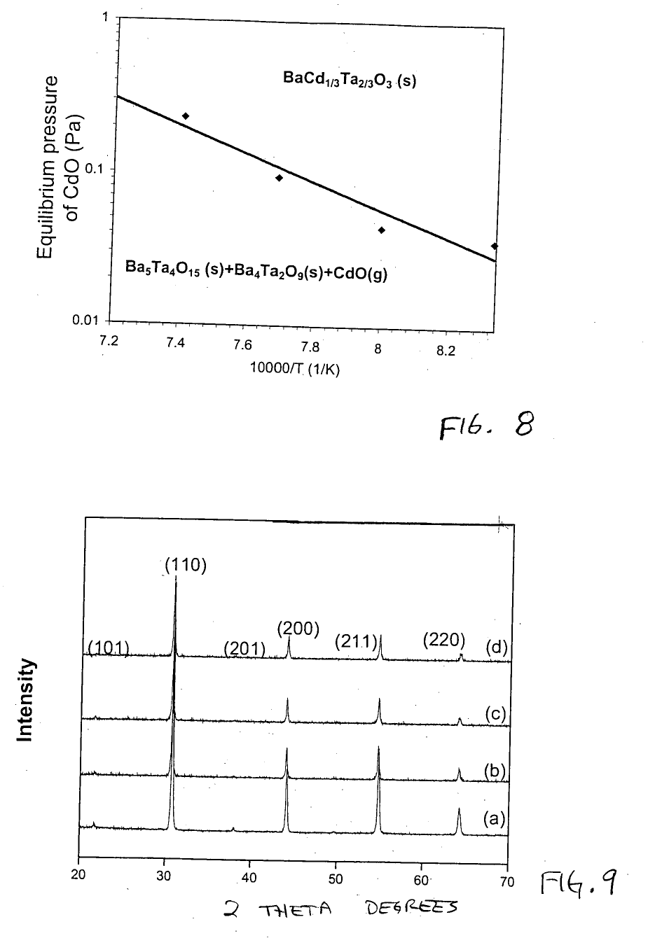

X-Ray diffraction spectra of Ba(ZnₓCd_{1/3-x}Ta_{2/3})O₃ alloy powders, shown as traces (a)-(d) in FIG. 9, indicate that the present BCT material forms solid solutions over the entire range of alloy compositions. It also shows that Ba(ZnₓCd_{1/3-x}Ta_{2/3})O₃ alloys do not exhibit significant levels of long range ordering, as indicated by the absence of superstructure peaks or characteristic splitting of the (220) and (214) peaks. Earlier investigations have shown that solid alloy solutions with chemically similar B-site components (i.e. similar ionic sizes and electronegativity), such as occurs for in magnesium-niobium titanate, can help to stabilize the disordered crystalline structure.

Table 1 shows the inferred lattice constants of these powder samples assuming either a cubic or hexagonal structure. Since the amount of ordering in the powders is not significant, it is more appropriate to fit to the cubic structure. Both structures are mentioned since this class of materials typically exhibits varying levels of ordering. The hexagonal structure represents the completely ordered alloy, while the cubic structure represents the random alloy.

TABLE 1
Lattice positions in Cartesian coordinates

| | BZT | | | BCT | | |
|---|---|---|---|---|---|---|
| Ba2 | 0.0000 | 0.0000 | 0.0000 | 0.0000 | 0.0000 | 0.0000 |
| Ba | 0.3333 | −0.3333 | 0.3386 | 0.3333 | −0.3333 | 0.3398 |
| Ba | −0.3333 | 0.3333 | −0.3386 | −0.3333 | 0.3333 | −0.3398 |
| Ta | 0.3333 | −0.3333 | −0.1754 | 0.3333 | −0.3333 | −0.1670 |
| Ta | −0.3333 | 0.3333 | 0.1754 | −0.3333 | 0.3333 | 0.1670 |
| Zn(Cd) | 0.0000 | 0.0000 | −0.5000 | 0.0000 | 0.0000 | 0.5000 |
| O1 | 0.0000 | −0.5000 | 0.0000 | 0.0000 | −0.4836 | 0.0000 |
| O1 | −0.5000 | −0.5000 | 0.0000 | 0.4836 | 0.4836 | 0.0000 |
| O1 | 0.5000 | 0.0000 | 0.0000 | −0.4836 | 0.0000 | 0.0000 |
| O2 | 0.1714 | 0.3428 | −0.3245 | 0.1539 | 0.3507 | −0.3153 |
| O2 | −0.1714 | −0.3428 | 0.3245 | −0.1969 | −0.3507 | 0.3153 |
| O2 | −0.1714 | 0.1714 | 0.3245 | −0.1539 | 0.1969 | 0.3153 |
| O2 | 0.3428 | 0.1714 | 0.3245 | 0.3507 | 0.1539 | 0.3153 |
| O2 | −0.3428 | −0.1714 | −0.3245 | −0.3507 | −0.1969 | −0.3153 |
| O2 | 0.1714 | −0.1714 | −0.3245 | 0.1969 | −0.1539 | −0.3153 |

FIG. 10 shows X-Ray diffraction spectra of sintered BCT material synthesized with 2 wt % ZnO as sintering additive. The traces are run a variety of temperatures: 1450° C., 1450° C. (doped with 1 wt % Ni), 1520° C., 1550° C., and 1580° C. Evidence for Cd—Ta ordering, as indicated by the presence of superstructure peaks in the X-ray diffraction spectra, is found to be most predominant for samples sintered at 1450° C. In general, the extent of long range ordering in the B position ions increases as the difference in the size of these ions become larger. Ordering is therefore expected to be more favorable in the BCT material than in BZT. X-ray diffraction simulations of ordered structures indicate that BCT spectra show about 3 times larger superstructure peaks for the same level of ordering due to the larger difference in scattering amplitude, i.e. larger ΔZ.

The extent of Cd—Ta ordering is determined to be a function of temperature. For BCT material, Cd—Ta ordering is greatest when sintered at 1450° C. and diminishes for higher temperature processing. BCT sintered at 1550° C. exhibits a dielectric constant of 39 and loss tangent of 5×10⁻⁵ at 2 GHz. Thermogravimetric measurements are used to infer thermodynamic parameters for BCT. Ab-initio electronic structure calculations can be used to give insight into the properties of the present class of BCT materials. While the present system has a hexagonal Bravais lattice, the space group of BCT is different from P3 ml of BZT P321 as a result of a distortion of oxygen away from the symmetric position between the Ta and Cd ions. The CBM and VBM are composed of mostly weakly itinerant Ta-5d and Zn-3d/Cd-4d levels, respectively. The covalent nature of the d-electron directional bonding in these high-Z oxides plays a role in producing a more rigid lattice with higher melting points and enhanced phonon energies.

Higher temperature sintering result in reduced levels of cation ordering, indicating an order-disorder temperature of about 1500° C. Additional peaks in the spectra are found at the elevated temperatures that do not match the expected decomposition product, which may be attributed to the formation of intermediate or meta-stable phases as a result of partial decomposition.

The density of BCT is very low if a sintering additive is not used. A significantly improved densification of BCT ceramics is attained with the addition of ZnO as a sintering aid. The sintering density of the formulation reaches a maximum at 1450° C. With increasing temperature, the sintering density decreases. The decrease in density after high temperature sintering is presumably due to the evaporation of ZnO and CdO, as would be inferred from the thermogravimetry results.

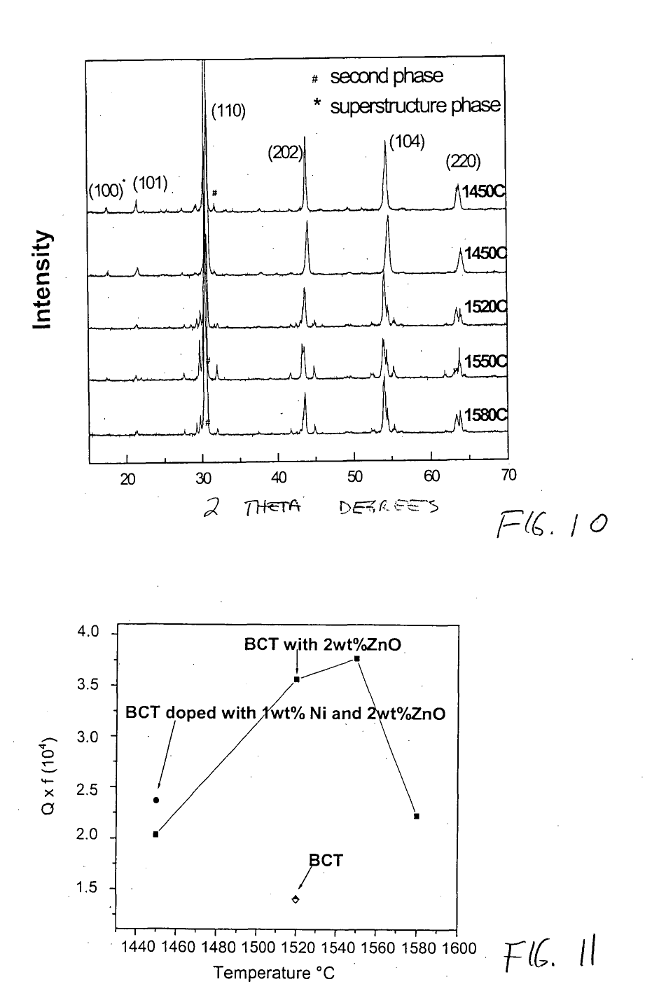

FIG. 11 illustrates the Q*f product, i.e. microwave quality factor times resonant frequency, of BCT samples synthesized with 2 wt % ZnO sintering agent over a range of temperatures. The inverse of the Q-factor is an accurate determination of the loss tangent for the given measurement conditions. The Q*f product of BCT is improved substantially when the ZnO sintering agent is added. The Q*f product exhibits a maximum at a sintering temperature of about 1550° C. The highest Qs are attained in samples that do not exhibit as strong a B-site cation ordering as the 1550° C. sintered samples. The extent of ordering significantly influences ceramic dielectric properties. The use of Zr doping is found to produce material whose loss did not directly correlate with the degree of bulk cation ordering. The influence of lattice defects (vacancies, impurities, dislocations), secondary phases, porosity, and/or other microstructure-related defects can strongly affect Q at microwave frequency.

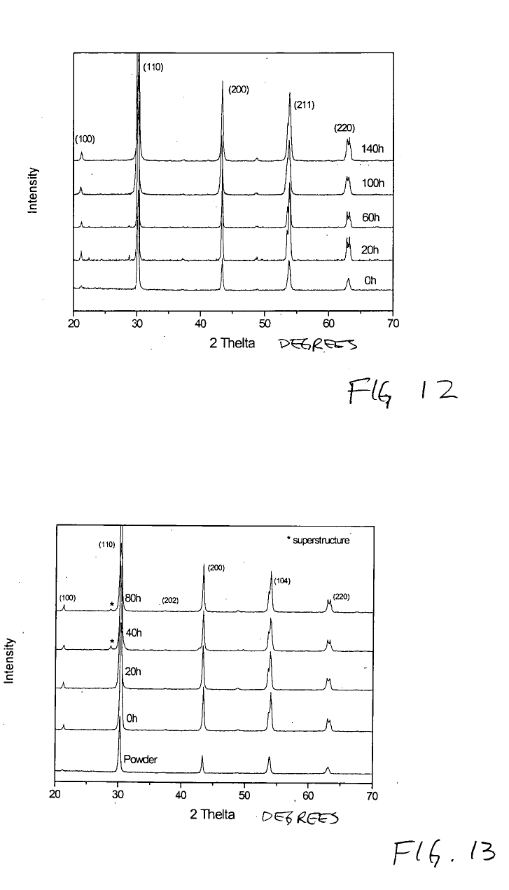

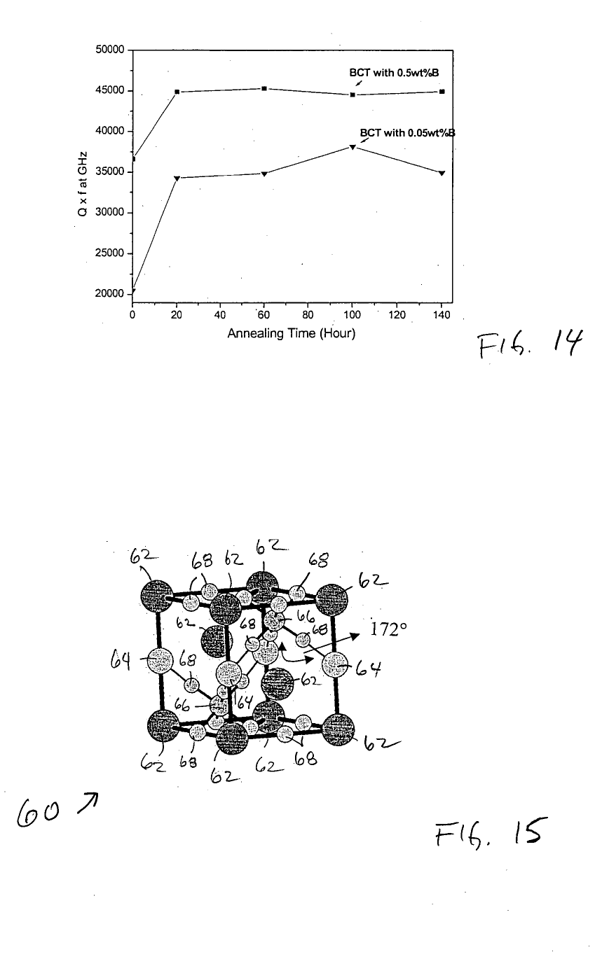

FIG. 12 X-Ray diffraction spectra of BCT with 0.5 wt % B annealed at 1050° C. as a function of annealing time. FIG. 13 X-Ray diffraction spectra of BCT with 0.5 wt % B annealed at 1250° C. as a function of annealing time. FIG. 14 shows the effect of annealing time on the microwave property at 1050° C. with different boron content. The results show that addition annealing can result in significant improvements in the microwave properties. The Q*f product increases from about 21000 to 34000 for sample with 0.05 wt % B annealed at 1050° C. for 20h. The sample with 0.5 wt % at the same condition shows that higher amounts of boron can be used to significantly improve these values, with a Q*f product about 45000 being attained. The use of Boron as a sintering aid facilitated the production of high sintering density 98% ceramics at relative low sintering temperature of 1300° C. and short sintering times of about 2 hrs.

Since the density is significantly below 100% of the theoretical value, a corrected value for the presence of voids is also shown for the comparison. In particular, the measured dielectric constant for the BCT samples is corrected for the errors introduced by air-filled pores using the following equation:

$${ϵ}_{r} = exp [ ln \{ {V}_{1} {ϵ}_{r1}^{( {V}_{1} - {V}_{2} )} + {V}_{2} {ϵ}_{r2}^{( {V}_{1} - {V}_{0} )} \} ] / ( {V}_{1} - {V}_{2} ) \qquad ( 1 )$$

where: εᵣ, εᵣ₁, εᵣ₂ are the relative dielectric constant of the mixture, material, and air, respectively, and V₁ and V₂ are the volume fractions of the material and air, respectively. V₀ is the critical volume fraction given as 0.65. A dielectric constant of about 38 can be inferred for BCT samples annealed above 1520° C. A low frequency (1 k to 1 MHz) dielectric constant is measured in parallel plate geometry with 0.85 mm thickness and 10 mm diameter to be 44.3 for BCT and 42.0 for BZT.

The above results are calculated and verified by the following equation:

$$f = \frac{34}{\sqrt{ϵ} \cdot a} ( \frac{a}{t} + 3.54 ) \qquad ( 2 )$$

where a is the sample radius in millimeters (mm), t is the sample thickness in mm, ε is the relative dielectric constant, and f is the resonance frequency in GHz. The dielectric constant of BCT doped with 1 wt % Ni and 2 wt % ZnO sintering aid from equation (2) is 35.9, which is close to 33.2, the dielectric constant measured by the DR method.

Local density calculations on BZT and BCT predict an equilibrium lattice constant of a=0.574 nm c=0.700 nm and a=0.583 nm c=0.717 nm, respectively. Note that the c/a ratio is very near (3/2)^{0.5}, as is characteristic of an undistorted pseudocubic crystal. The predicted lattice constants are slightly smaller (˜0.01%) since the theoretical method overbinds as a result of the LDA approximation. The BCT bulk modulus is predicted to be 1.91 Mbar; slightly less than the value for BZT at 1.99 Mbar as a result of the dilated lattice.

One difference between BCT and BZT is the additional distortion found in BCT that results in a bond angle of 1720 for the To—O—Cd bond. BZT has a threefold rotation about the c-axis, a twofold rotation about y, and finally an inversion symmetry, making 12 group operations in all. A ball and stick model of BCT 60 is shown in FIG. 15. Ba are shown as spheres 62; Cd/Zn as spheres 64; Ta as spheres 66; and 0 as spheres 68. The distortion relative to the bond-centered configuration has been amplified by a factor of five to more clearly show the distortion; in particular the buckling of the Ta—O—Cd bond. The Bravais lattice for Ba(Cd_{1/3}Ta_{2/3})O₃ is also hexagonal, but it falls in the P321 space group resulting from a distortion in the oxygen between the Ta and Cd due to the larger ionic size of the Cd ion. The intensity difference of the simulated x-ray spectra resulting from the distortion of the oxygen atoms is 0.01% and the change is too small to be resolved experimentally since larger variation of these peaks results from the presence of varying degrees of B-site ordering.

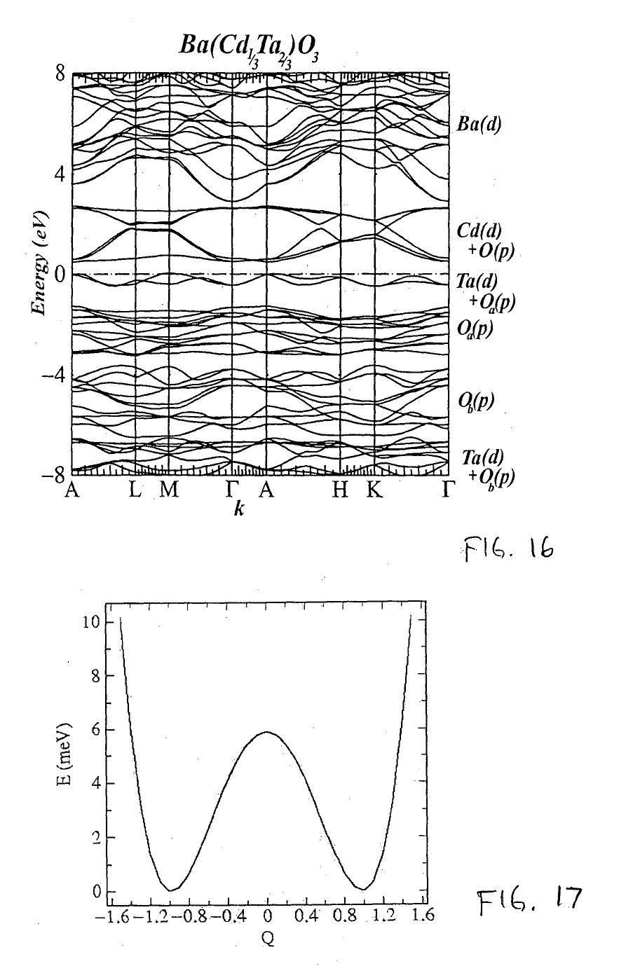

FIG. 16 illustrates the electronic energy band structure of BCT as calculated by the Linear Muffin Tin Orbital method within the Local Density Functional approximation. Energy is plotted as a function of crystal momentum. FIG. 17 illustrates energy as a function of the generalized coordinate Q. Q parameterizes the collective displacement of the oxygen atoms. Z=0 corresponds to the high-symmetry position of the oxygen atom between the Cd and Ta atoms, and Q=1 to the minimum energy configuration.

Note that the oxygen atom would be expected to oscillate between these positions at room temperature since the energy barrier separating the minima (6 meV) is small compared to thermal energies (26 meV). The associated phonon mode in this direction would therefore be anticipated to have a strong anharmonic component.

BCT has a typical physical properties due to its the contribution from the d-electron directional bonding. The presence of significant charge transfer between the cation d-orbitals is predicted to provide a degree of covalent directional bonding between atoms that resist angular distortions, a property absent in conventional ionic compounds. This may strengthen “soft lattice modes” correlated with microwave loss, as might occur in both defective and high-quality ionic compounds. The influence of the d-electron type bonding, as compared to conventional non-directional metal-oxygen ionic bonding, may play a role in achieving high melt temperatures and enhanced phonon energies. The latter may presumably play a role in the ultra-low microwave loss (loss tangent) that is observed in the present class of BCT materials. In the case of Ba (Cd_{1/3}Ta_{2/3})O₃ and Ba (CdₓZn_{1/3-x}Ta_{2/3})O₃, the LDA approximation indicates that charge is transferred from Ta-5d levels in the conduction band (empty states near CBM) to Cd-4d and Zn-3d levels (full states near VBM). Typically phonon energies inversely scale with the bond distance. Therefore, high Z materials tend to have reduced phonon energies and enhanced loss tangents. The high dielectric constant of high Z material is largely a result of the large polarizability of the core electrons. The presence of a significant amount of d-electron covalent bonding in a compound with many high-Z components such as Ba(CdₓZn_{1/3-x}Ta_{2/3})O₃ can result in enhanced the phonon energies, possibly resulting in reduced microwave loss, while still maintaining a large dielectric constant.

Also, calculations show that the bottom of the conduction band is composed mostly of Ta-5d states and the top of the conduction band is mostly Cd-4d (with some Zn-3d) states, and therefore the optical transition is nearly forbidden. Due to the spatial separation (i.e. minimal overlap) of these localized levels and because it is a forbidden d-d transition, the lifetime for recombination can be long. This has applications for laser material since electrons could be efficiently pumped from the VB to higher states in the CB, while the transition from the CBM to VBM would be slow.

The present invention has been described with respect to preferred embodiment(s). Any person skilled in the art will recognize that changes can be made in form and detail, and equivalents may be substituted for elements of the invention without departing from the spirit and scope of the invention. Many modifications may be made to adapt to a particular situation or material to the teaching of the invention without departing from the essential scope of the invention. Therefore, it is intended that the invention not be limited to the particular embodiments disclosed for carrying out this invention, but that the invention will include all embodiments falling within the scope of the following claims.

What is claimed is:

1. A dielectric comprising a solid material including elements of barium, cadmium, and tantalum.

2. The dielectric of claim 1 wherein the cadmium and tantalum are combined in a predetermined ratio.

3. The dielectric of claim 2 wherein the predetermined ratio is one-third cadmium and two-thirds tantalum.

4. The dielectric of claim 2 wherein the cadmium and tantalum are combined over a range of values.

5. The dielectric of claim 1 wherein the solid material further includes an element with valence 2.

6. The dielectric of claim 5 wherein the element is selected from a group of zinc and magnesium.

7. The dielectric of claim 6 wherein the cadmium, zinc, and tantalum are combined in a predetermined ratio.

8. The dielectric of claim 1 wherein the material includes Ba_{1+y}(Cdₓ₊ₐM_{1/3-x}Ta_{2/3})O_{3+z} wherein −0.1<a<0.1, 0<x<0.333, −00.1<y<0.1 and −00.1<z<0.1.

9. The dielectric of claim 1 wherein the material includes Ba_{1+y}(Cd_{1/3+a}Ta_{2/3})O_{3+z}, wherein −00.1<a<0.1, 0<x<0.333, −00.1<y<0.1 and −0.1<z<0.1.

10. An electronic device, comprising:
a region providing an electrical function, wherein the region includes a solid material having at least elements of barium, cadmium, and tantalum; and
an electrical terminal connected to the region.

11. The electronic device of claim 10 where the region provides a resonator electrical function.

12. The electronic device of claim 10 where the region provides a passive electrical function.

13. The electronic device of claim 10 wherein the material includes Ba_{1+y}(Cdₓ₊ₐM_{1/3-x}Ta_{2/3})O_{3+z} wherein −0.1<a<0.1, 0<x<0.333, −0.1<y<0.1 and −0.1<z<0.1.

14. The electronic device of claim 10 wherein the material includes Ba_{1+y}(Cd_{1/3+a}Ta_{2/3})O_{3+z}, wherein −0.1<a<0.1, 0<x<0.333, −0.1<y<0.1 and −0.1<z<0.1.

15. The electronic device of claim 10 wherein the cadmium and tantalum are combined in a predetermined ratio.

16. The electronic device of claim 10 wherein the solid material further includes an element with valence 2.

17. The electronic device of claim 16 wherein the element is selected from a group of zinc and magnesium.

18. An optical device, comprising:
a region comprising a solid material including elements of barium, cadmium, and tantalum; and
an input connected to the region.

19. The optical device of claim 18 wherein the cadmium and tantalum are combined in a predetermined ratio.

20. The optical device of claim 18 wherein the solid solution further includes an element with valence 2.

21. The optical device of claim 20 wherein the element is selected from a group of zinc and magnesium.

22. A method of making a ceramic dielectric material, comprising:
blending a mixture including barium, cadmium, and tantalum;
drying and heating the mixture; and
pressing the mixture into the ceramic dielectric material.

23. The method of claim 22 further including adding a sintering agent to the mixture.

24. The method of claim 22 further including adding an adhesive to the mixture before pressing the mixture into the ceramic dielectric material.

25. The method of claim 22 further including the step of making the ceramic dielectric material by solid state reaction synthesis.

26. The method of claim 22 further including the step of making the ceramic dielectric material by mechanical activation synthesis by mechanical alloying the mixture of barium oxide, cadmium oxide, and tantalum oxide.

27. The method of claim 25 further including the step of making the ceramic dielectric material by chemistry-based processing to synthesize the nanosized BCT including co-precipitation, sol-gel synthesis, alkoxide hydrolysis, and citrate routes.

28. A method of making a thin film dielectric material, comprising:
blending a mixture including barium, cadmium, and tantalum;
drying the mixture;
exposing the mixture to a laser; and
growing the thin film dielectric material on a substrate.

29. The method of claim 28 further including adding a sintering agent to the mixture.

30. The method of claim 28 further including the step of growing the thin film dielectric material on a substrate using sputtering, co-evaporation, molecular beam epitaxy, or chemical vapor deposition.
